(19) United States
(12) Patent Application Publication
(10) Pub. No.: US 2023/0227110 A1
(43) Pub. Date: Jul. 20, 2023

(54) WIPER COVERING SYSTEM

(71) Applicants: Hyundai Motor Company, Seoul (KR); Kia Corporation, Seoul (KR)

(72) Inventors: Nak Kyoung KONG, Seongnam-Si (KR); Jong Min PARK, Seoul (KR)

(73) Assignees: Hyundai Motor Company, Seoul (KR); Kia Corporation, Seoul (KR)

(21) Appl. No.: 17/982,385

(22) Filed: Nov. 7, 2022

(30) Foreign Application Priority Data
Jan. 14, 2022 (KR) 10-2022-0005659

(51) Int. Cl. B62D 25/08; B60S 1/04; B60S 1/52

(52) U.S. Cl. CPC B62D 25/081; B60S 1/0463; B60S 1/52; B60S 1/0818

(57) ABSTRACT

A wiper covering system includes a wiper cover; and a drive mechanism connected to the wiper cover and including a link structure configured to move the wiper cover.

### CROSS-REFERENCE TO RELATED APPLICATION

The present application claims priority to Korean Patent Application No. 10-2022-0005659 filed on Jan. 14, 2022, the entire contents of which is incorporated herein for all purposes by this reference.

### BACKGROUND OF THE PRESENT DISCLOSURE

### Field of the Present Disclosure

The present disclosure relates to a wiper for a vehicle, and more specifically, to a wiper covering system for a vehicle.

### Description of Related Art

A windshield for a vehicle is provided with a wiper system to help a driver secure forward visibility. When it rains or snows while a vehicle travels, a wiper may wipe the rain or snow that stays or flows on the windshield, or the wiper may clean the windshield with a washer fluid sprayed onto the windshield contaminated with dust.

As shown in FIG. 1, a wiper blade W is exposed outside and mounted at a lower side of a windshield WS of a vehicle V and an upper side of a hood H thereof. As described above, there is a problem in that the wiper blade W exposed outside causes wind noise while the vehicle travels, and degrades the aesthetic appearance.

As a mounting location of the wiper blade W has a close connection with a windshield mounting process, an A-pillar, a hood, and the like the mounting location is limited by these conditions. For example, when the windshield WS is mounted after the hood H is provided, an end portion of the windshield WS should be spaced from the hood by a certain interval. Furthermore, as an angle a of the A-pillar A decreases, a location of an end portion (indicated by a circle in FIG. 1) of the wiper blade W gradually moves upwards from the lower side of the windshield WS to satisfy a wiping area. Besides, the end portion of the wiper blade W is positioned at the end portion of the windshield WS as closely as possible to satisfy the regulations required for the wiping area of the wiper so that as wide areas as possible is wiped.

These conditions force the wiper blade W to be exposed to the outside thereof, impair the external design, and cause excessive wind sound.

Accordingly, it is necessary to devise a structure which may solve the problem caused by the wire blade exposed to the outside.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a wiper covering system for solving overall problems including degradation in the aesthetic appearance, wind sound, etc., caused by a mounting location of a wiper blade exposed to the outside.

The object of the present disclosure is not limited to the above-described object, and other objects not mentioned will be clearly understood by those skilled in the art to which the present disclosure pertains (hereinafter, referred to as ‘those skilled in the art’) from the following description.

To achieve the object of the present disclosure and perform the characteristic functions of the present disclosure to be described later, the characteristics of the present disclosure are as follows.

According to various exemplary embodiments of the present disclosure, a wiper covering system includes a wiper cover; and a drive mechanism connected to the wiper cover and including a link structure configured to move the wiper cover.

According to various exemplary embodiments of the present disclosure, a vehicle includes a wiper cover configured to be movable between a storage location inside a hood of a vehicle and a drawn-out location on a windshield thereof; and a drive mechanism mounted on a cowl top cover disposed under the hood, and connected to the wiper cover via at least two link structures to move the wiper cover.

According to an exemplary embodiment of the present disclosure, there is presented the wiper covering system that can solve the overall problems including degradation in the aesthetic appearance, wind sound, etc., caused by a mounting location of a wiper blade exposed to the outside.

The effect of the present disclosure is not limited to the above-described effect, and other effects not mentioned will be clearly recognized by those skilled in the art from the following description.

It is understood that the term “automotive” or “vehicular” or other similar term as used herein is inclusive of motor automotives in general such as passenger automobiles including sports utility automotives (operation SUV), buses, trucks, various commercial automotives, watercraft including a variety of b oats and ships, aircraft, and the like, and includes hybrid automotives, electric automotives, plug-in hybrid electric automotives, hydrogen-powered automotives and other alternative fuel automotives (e.g., fuels derived from resources other than petroleum). As referred to herein, a hybrid automotive is an automotive that has two or more sources of power, for example both gasoline-powered and electric-powered automotives.

The above and other features of the present disclosure are discussed infra.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 shows a windshield fora vehicle;

FIG. 2 shows a state in which a wiper covering system according to an exemplary embodiment of the present disclosure is mounted on a vehicle;

FIG. 3 is a partial enlarged view of FIG. 2;

FIG. 4 shows an end portion of a cowl top cover according to an exemplary embodiment of the present disclosure;

FIG. 5 shows a base mounted on the cowl top cover in an exemplary embodiment of the present disclosure;

FIG. 6 shows the base according to an exemplary embodiment of the present disclosure viewed from one side;

FIG. 7 shows the base according to an exemplary embodiment of the present disclosure viewed from the other side;

FIG. 8 and FIG. 9 show a motor according to an exemplary embodiment of the present disclosure and the motor mounted on the base;

FIG. 10 shows a drive mechanism according to an exemplary embodiment of the present disclosure viewed from one side of the base;

FIG. 11 shows a drive mechanism according to an exemplary embodiment of the present disclosure viewed from the other side of the base;

FIG. 12 shows a washer fluid nozzle according to an exemplary embodiment of the present disclosure;

FIG. 13 shows a wiper covering system according to an exemplary embodiment of the present disclosure;

FIG. 14 shows a signal flow of the wiper covering system according to an exemplary embodiment of the present disclosure;

FIG. 15 is an operation flowchart of the wiper covering system according to various exemplary embodiments of the present disclosure; and

FIG. 16, FIG. 17, FIG. 18 and FIG. 19 schematically show an operation of a link structure according to an exemplary embodiment of the present disclosure.

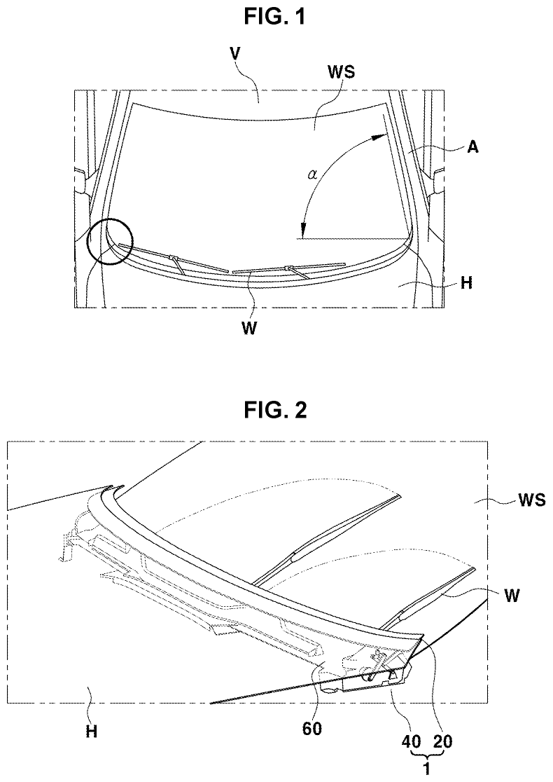

It may be understood that the appended drawings are not necessarily to scale, presenting a somewhat simplified representation of various exemplary features illustrative of the basic principles of the present disclosure. The specific design features of the present disclosure as included herein, including, for example, specific dimensions, orientations, locations, and shapes will be determined in section by the particularly intended application and use environment.

In the figures, reference numbers refer to a same or equivalent sections of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Specific structural or functional descriptions presented in the exemplary embodiments of the present disclosure are only exemplified for describing the exemplary embodiments according to the concept of the present disclosure, and the exemplary embodiments according to the concept of the present disclosure may be conducted in various forms. Furthermore, the present disclosure should not be construed as being limited to the exemplary embodiments described herein, and should be understood to include all modifications, equivalents, and substitutes included in the spirit and technical scope of the present disclosure.

Meanwhile, in the present disclosure, terms such as first and/or second may be used to describe various components, but the components are not limited by the terms. The above terms are used only for distinguishing one component from other components, for example, a first component may be named as a second component, and similarly, the second component may also be named as the first component without departing from the scope according to the concept of the present disclosure.

When a component is “connected” or “coupled” to another component, it should be understood that a component may be directly connected or coupled to another component, but other components may exist therebetween. On the other hand, when a component is “directly connected” or “in direct contact with” another component, it should be understood that no other components exist therebetween. Other expressions for describing the relationship between components, that is, expressions such as “between” and “directly between” or “adjacent to” and “directly adjacent to”, should be interpreted in a similar manner.

The same reference numerals refer to the same components throughout the specification. Meanwhile, the terms used herein is for describing the embodiments, and is not intended to limit the present disclosure. In the present specification, the singular form also includes the plural form unless otherwise predetermined in the phrase. “Comprises” and/or “comprising” used herein means that the presence or addition of one or more other components, steps, operations, and/or elements other than the stated component, step, operation, and/or element is not precluded.

The present disclosure is configured to selectively hide a wiper exposed outside. To the present end, a wiper covering system according to an exemplary embodiment of the present disclosure includes a wiper cover which may be stored into a hood or drawn out from the hood. The wiper cover may be drawn out from under the hood or stored under the hood through a pinion gear rotated by a motor provided on a lateral end portions of a cowl top cover and a multi-joint link structure.

Furthermore, according to the wiper covering system of the present disclosure, a nozzle for a washer fluid and a hose for the washer fluid are provided on the wiper cover itself so that the washer fluid is sprayed to the windshield in conjunction with an operation of the wiper cover.

According to an exemplary embodiment of the present disclosure, it is possible to hide the wiper from the outside thereof by drawing out the wiper cover, improving the aesthetic appearance. Furthermore, it is possible to prevent the wiper from being frozen due to drifted snow which may occur while a vehicle is parked or stopped and to minimize the deterioration in durability of the wiper blades due to sunlight. Furthermore, it is possible to solve the problem of the occurrence of wind sound and the degradation in aerodynamic performance, caused by the exposure of the wiper and the wiper blades while driving without using the wiper or the washer fluid.

Hereinafter, the present disclosure will be described in detail with reference to the accompanying drawings.

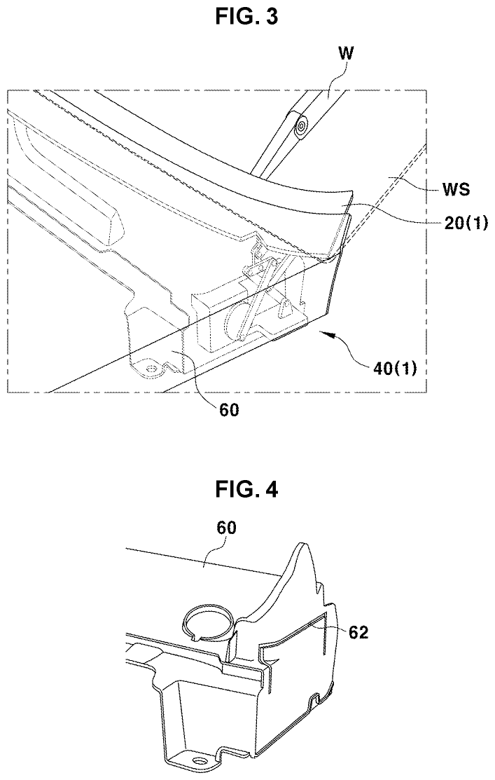

As shown in FIG. 2 and FIG. 3, a wiper covering system 1 according to an exemplary embodiment of the present disclosure includes a wiper cover 20 and a drive mechanism 40.

The wiper cover 20 may move between inside of the hood H and an outside of the hood H. In a state in which the wiper cover 20 is stored, the wiper cover 20 is located inside the hood H. In a state in which the wiper cover 20 is drawn out, the wiper cover 20 is located outside the hood H and on the windshield WS to cover the wiper blades W. Accordingly, when the wiper cover 20 is drawn out, the same effect as that of the extension of the hood H is provided. In the state in which the wiper cover 20 is stored, the wiper blades W are in a state of being exposed to the outside. In the state in which the wiper cover 20 is drawn out, the wiper blades W remain hidden and invisible from the outside.

The drive mechanism 40 enables a change in a position of the wiper cover 20. In other words, the drive mechanism 40 movably operates the wiper cover 20. The drive mechanism 40 may be connected to the wiper cover 20 to move the wiper cover 20. For example, the drive mechanism 40 may be connected to a connection portion 22 provided under the wiper cover 20. The connection portion 22 includes a proximal connection portion 22a and a distal connection portion 22b. In an exemplary embodiment of the present disclosure, the proximal connection portion 22a is located at a front side in a front and rear direction of the vehicle, and the distal connection portion 22b is located behind the proximal connection portion 22a in the front and rear direction of the vehicle. However, the locations of the proximal connection portion 22a and the distal connection portion 22b may be changed depending on an arrangement of a link structure 440 to be described later.

According to an exemplary embodiment of the present disclosure, the drive mechanism 40 includes a base 140, a motor 240, a gear 340, and a link structure 440. Although the drive mechanism 40 is provided at each end portion of a cowl top cover 60, only one drive mechanism at one end portion of the cowl top cover 60 is described below to avoid repetition.

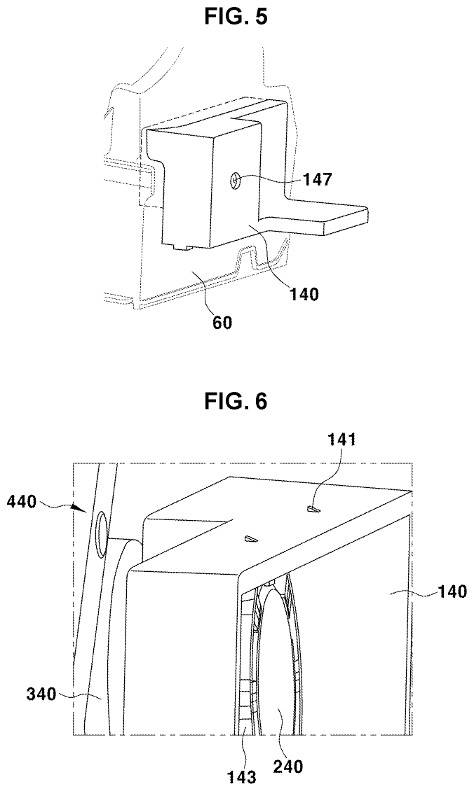

The base 140 is configured as a basic structure of the drive mechanism 40. The base 140 may be supported and mounted on a lateral side of the cowl top cover 60. As shown in FIG. 4 and FIG. 5, according to an exemplary embodiment of the present disclosure, the lateral side of the cowl top cover 60 is provided with an accommodation portion 62. The base 140 is inserted into the accommodation portion 62, and the base 140 is mounted on the cowl top cover 60. According to an exemplary embodiment of the present disclosure, the accommodation portion 62 is formed in the same shape as a periphery of the base 140, and the base 140 is fitted into and coupled to the accommodation portion 62. According to an exemplary embodiment of the present disclosure, as shown in FIG. 6, a locking portion 141 is provided on an external surface of the base 140. The locking portion 141 may be a portion protruding from the surface of the base 140, and may prevent the base 140 from being easily separated from the cowl top cover 60 after the base 140 is inserted into the accommodation portion 62.

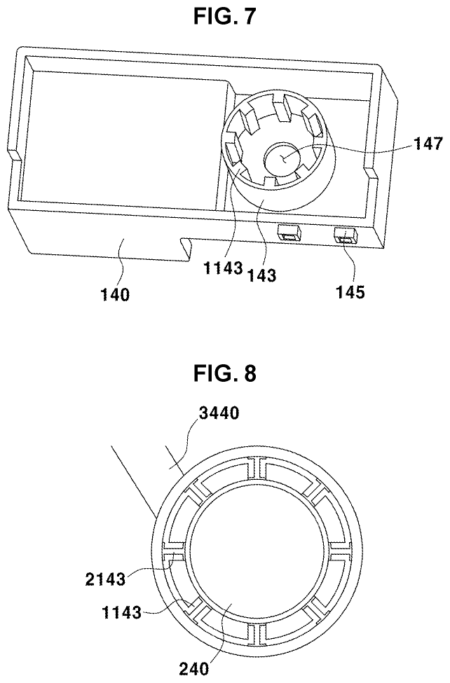

As shown in FIG. 7, the base 140 includes a seat 143. The seat 143 is provided on one side of the base 140. For example, the side of the base 140 may be a side facing the interior of a vehicle. In various exemplary embodiments of the present disclosure, the seat 143 is provided with a plurality of ribs 1143. Each rib 1143 protrudes from an internal surface of the seat 143 toward a center portion of the seat 143. The ribs 1143 are spaced from each other by a certain distance along a circumference of the seat 143.

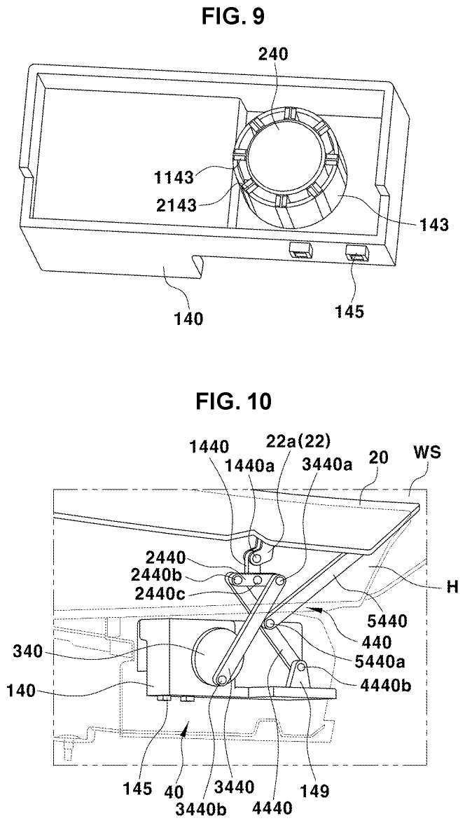

Referring to FIG. 8 and FIG. 9, in various exemplary embodiments of the present disclosure, at least some of the plurality of ribs 1143 may include a heat dissipation fin 2143. For example, the heat dissipation fin 2143 may be made of a metallic material, such as aluminum, having excellent heat dissipation characteristic. The heat dissipation fin 2143 may be included in the rib 1143 by a manufacturing method, such as insert injection molding.

A motor 240 is accommodated on the seat 143. In an exemplary embodiment of the present disclosure, the motor 240 is fixed to the seat 143 by the ribs 1143. The motor 240 provides a driving force to the drive mechanism 40. The motor 240 may generate power configured for drawing out or storing the wiper cover 20 through forward or reverse rotation, and may be controlled according to specific conditions. The motor 240 is controlled by a motor control unit 250 configured to control an operation of the motor 240 based on various inputs.

Referring back to FIGS. 7 and 8, in various exemplary embodiments of the present disclosure, the base 140 includes one or more drain holes 145. Each drain hole 145 is configured to discharge moisture which may be formed within the base 140 to the outside of the base 140. Each drain hole 145 may be formed on a bottom or lower surface of the base 140.

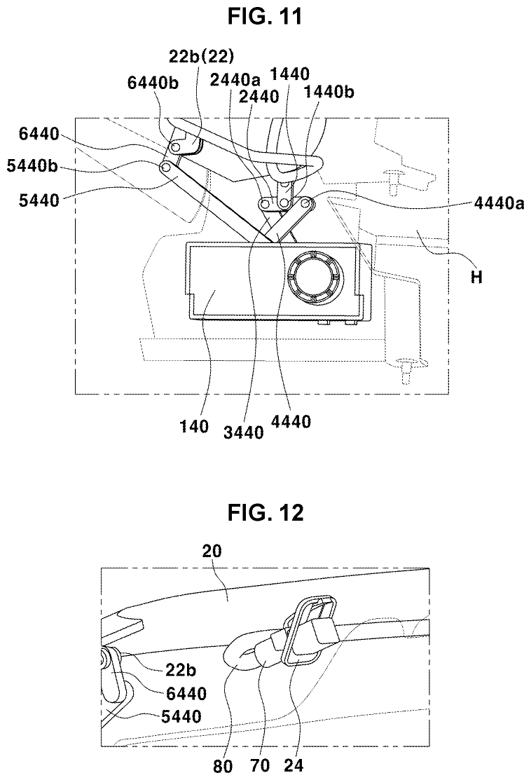

As shown in FIG. 10, and FIG. 11, a gear 340 is mounted on the motor 240. The gear 340 is mounted on the other side of the base 140, as opposed to the one side of the base 140 where the seat 143 is provided. Here, the other side may be a surface facing the outside of the vehicle. A driveshaft of the motor 240 passes through the base 140 through a hole 147 of the base 140, and the gear 340 may be mounted on the passed-through driveshaft. The gear 340 is configured to be rotated together by the rotation of motor 240. The gear 340 is connected to the driveshaft of the motor 240 to transmit a rotation force to the link structure 440.

The link structure 440 is connected to the gear 340. The gear 340 moves the link structure 440 by rotation thereof and the link structure 440 is connected to the wiper cover 20 to move the wiper cover 20. The link structure 440 is connected to the gear 340 to convert the rotation force into a force in a direction of storing or drawing out the wiper cover 20 to transmit the converted force. According to an exemplary embodiment of the present disclosure, the link structure 440 includes a vertical link 1440, a horizontal link 2440, a direct link 3440, an indirect link 4440, a connection link 5440, and a distal end link 6440.

The name of each link is provided for the distinction purpose only. Hereinafter, connection points formed at end portions of each link, respectively will be referred to by matching the names. For example, the vertical link 1440 includes a first vertical link point 1440a and a second vertical link point 1440b at opposite end portions of the vertical link 1440, respectively. Connection points provided at opposite end portions of the horizontal link 2440 are referred to as a first horizontal link point 2440a and a second horizontal link point 2440b. Connection points provided at opposite end portions of the direct link 3440 are referred to as a first direct link point 3440a and a second direct link point 3440b. Connection points provided at opposite end portions of the indirect link 4440 are referred to as a first indirect link point 4440a and a second indirect link point 4440b. Connection points provided at opposite end portions of the connection link 5440 are referred to as a first connection link point 5440a and a second connection link point 5440b. Connection points provided at opposite end portions of the distal end link 6440 are referred to as a first distal end link point 6440a and a second distal end link point 6440b, respectively.

The vertical link 1440 is connected to the wiper cover 20. The vertical link 1440 is mounted on the proximal connection portion 22a of the wiper cover 20. The vertical link 1440 may be mounted on the proximal connection portion 22a by the first vertical link point 1440a. The first vertical link point 1440a is fixed not to be rotatable with respect to the proximal connection portion 22a.

The horizontal link 2440 is mounted on the second vertical link point 1440b of the vertical link 1440. The horizontal link 2440 includes a coupling point 2440c provided between the first horizontal link point 2440a and the second horizontal link point 2440b, and the second vertical link point 1440b and the coupling point 2440c may be coupled. The horizontal link 2440 is coupled not to be rotatable about the vertical link 1440.

The direct link 3440 is coupled to the first horizontal link point 2440a. The horizontal link 2440 and the direct link 3440 are coupled by the first horizontal link point 2440a and the first direct link point 3440a. The first direct link point 3440a is configured to be rotatable with respect to the first horizontal link point 2440a. The second direct link point 3440b is connected to the gear 340.

The indirect link 4440 is connected to the second horizontal link point 2440b. The first indirect link point 4440a is rotatably coupled to the second horizontal link point 2440b. The second indirect link point 4440b is coupled to a fixing portion 149 formed in the base 140. The second indirect link point 4440b is rotatably coupled with respect to the fixing portion 149. Here, the direct link 3440 and the indirect link 4440 may intersect with each other, but may intersect with each other without coming into contact with each other. An intermediate point 4440c is provided between the first indirect link point 4440a and the second indirect link point 4440b, and the connection link 5440 is connected to the intermediate point 4440c.

The connection link 5440 is coupled to the intermediate point 4440c of the indirect link 4440 through the first connection link point 5440a. Also, the connection link 5440 is coupled to the distal end link 6440 through the second connection link point 5440b. The connection link 5440 may be rotated with respect to the first connection link point 5440a and the second connection link point 5440b.

The distal end link 6440 is coupled to the connection link 5440 through the first distal end link point 6440a, and is coupled to the distal connection portion 22b through the second distal end link point 6440b. The distal end link 6440 may be rotated with respect to the first distal end link point 6440a and the second distal end link point 6440b.

An operation of the link structure 440 according to an exemplary embodiment of the present disclosure will be described later.

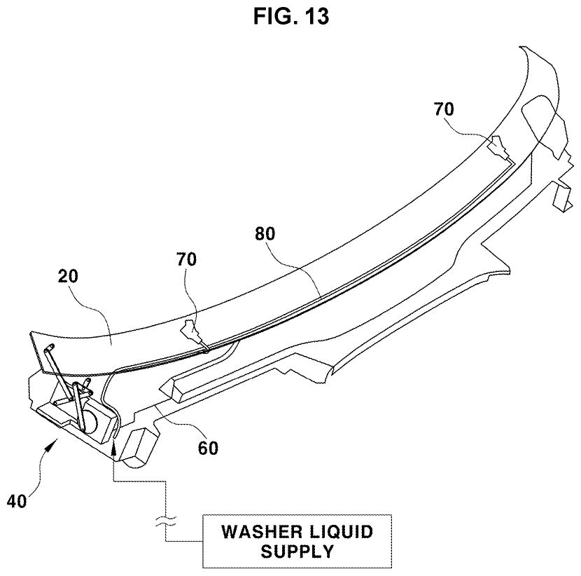

Referring to FIG. 12, and FIG. 13, a washer fluid nozzle 70 for the wiper is integrally provided in the wiper cover 20. A support portion 24 may be provided inside the wiper cover 20, and the washer fluid nozzle 70 may be mounted on the support portion 24. A washer fluid supply hose 80 extends along a lower portion of the wiper cover 20, and supplies the washer fluid to the washer fluid nozzle 70. The washer fluid nozzle 70 may spray the washer fluid to the windshield WS when the wiper cover 20 is stored. According to an exemplary embodiment of the present disclosure, the cowl top cover 60, the washer fluid nozzle 70, the washer fluid supply hose 80, and the wiper covering system 1 may be configured as one assembly.

According to various exemplary embodiments of the present disclosure, the wiper cover 20 may include a display device. By mounting a lighting or a display device, such as light emitting diode (LED) and a liquid crystal display (LCD), on the external surface of the wiper cover 20, this may be used for advertising or communication. In an exemplary embodiment of the present disclosure, various information may be transmitted to a driver by mounting a display device, a sensor, etc., on the internal surface of the wiper cover 20.

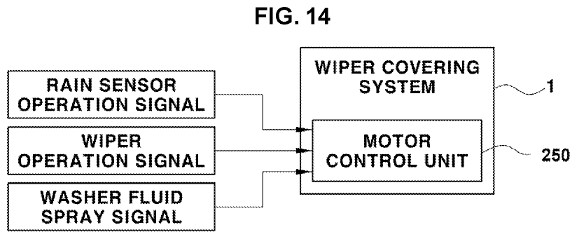

As shown in FIG. 14, an operation of the wiper covering system 1 may be controlled by a motor control unit 250. The motor control unit 250 is configured to control the driving of the motor 240 based on inputs so that the wiper cover 20 moves between the stored and drawn-out locations. In an exemplary embodiment of the present disclosure, the motor control unit 250 may be a vehicle control unit or may be a control unit separately provided for the wiper covering system 1.

The wiper covering system 1 may be operated based on inputs, such as an operation signal of a rain sensor for the vehicle, an operation signal of the wiper, a washer fluid spray signal, and a starting state of a vehicle. These signals may also be input to the motor control unit 250 through the vehicle control unit or may also be directly input to the motor control unit 250. In an exemplary embodiment of the present disclosure, when the operation signal of the rain sensor is input to the motor control unit 250, the motor control unit 250 drives the motor 240 to move the wiper cover 20 to the stored location. In an exemplary embodiment of the present disclosure, when the wiper operation signal or the washer fluid spray signal is input to the motor control unit 250, the motor 240 is driven to move the wiper cover 20 to the stored location. Here, the operation signal of the wiper or the washer fluid spray signal may be an input through a multifunction switch provided in a vehicle room of the vehicle. In an exemplary embodiment of the present disclosure, when the vehicle is turned off, the motor control unit 250 drives the motor 240 to position the wiper cover 20 to the drawn-out location.

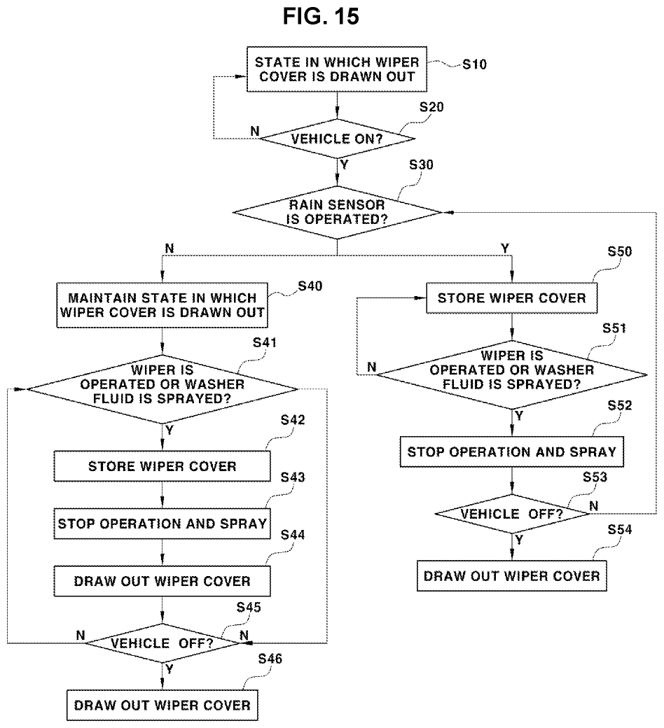

As shown in FIG. 15, the wiper covering system 1 according to an exemplary embodiment of the present disclosure is operated.

In operation S10, when the vehicle is turned off, the wiper cover 20 is located at the drawn-out location, and the motor control unit 250 detects whether the vehicle is turned on or started (S20). When the vehicle is turned on, the motor control unit 250 determines whether the rain sensor is in operation based on the signal of the rain sensor (S30).

When the rain sensor is not in operation, the motor control unit 250 maintains the drawn-out location of the wiper cover 20 without any additional operation (S40). In the meantime, the motor control unit 250 monitors whether the wiper is operated or the washer fluid is sprayed (S41). The operation of the wiper or the spray of the washer fluid may be determined based on the input from the multifunction switch.

When the wiper is operated or the washer fluid is sprayed, the motor control unit 250 drives the motor 240 to store the wiper cover 20 (S42). The motor control unit 250 continues to monitor whether the operation of the wiper and the spray of the washer fluid are stopped. Then when the operation of the wiper and the spray of the washer fluid are stopped (S43), the motor control unit 250 drives the motor 240 to draw out the wiper cover 20 (S44).

The motor control unit 250 detects whether a turn-off signal for the vehicle is input while continuously monitoring whether the wiper operation signal or the washer fluid spray signal is input (S45). When the turn-off signal is input, the motor control unit 250 maintains the wiper cover 20 in the drawn-out location (S46).

In operation S30, when the rain sensor operates when a vehicle is turned on, the motor control unit 250 drives the motor 240 to move the wiper cover 20 to the stored location (S50). Even at the instant time, the motor control unit 250 monitors whether the wiper operation signal or the washer fluid spray signal is input (S51), and detects whether the operation of the wiper or the spray of the washer fluid is terminated when the operation signal or the spray signal is input (S52).

Furthermore, the motor control unit 250 detects whether the turn-off signal for the vehicle is input (S53). When the turn-off signal is input, the motor control unit 250 drives the motor 240 to move the wiper cover 20 to the drawn-out location (S54). When the turn-off signal is not input, the motor control unit 250 determines whether the rain sensor is operated again to proceed to the corresponding operation.

While the rain sensor is in operation, the motor control unit 250 maintains the wiper cover 20 in the stored state regardless of whether the wiper is operated or the washer fluid is sprayed. This is for the immediate response of the wiper to rainwater or the like.

According to an exemplary embodiment of the present disclosure, a backup mode is included. The motor control unit 250 is configured to be operated in the backup mode by detecting a vehicle start condition when the motor control unit 250 fails to communicate with the wiper and the multifunction switch. In the backup mode, the motor control unit 250 automatically stores the wiper cover 20. In the backup mode, when the communication related to the operation of the wiper covering system 1 fails, the wiper cover 20 is located at the stored location to prevent the collision between the wiper and the wiper cover.

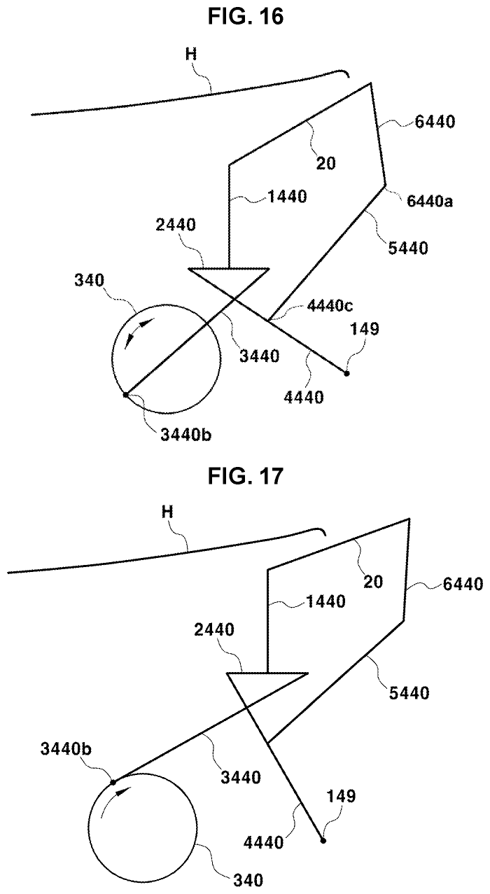

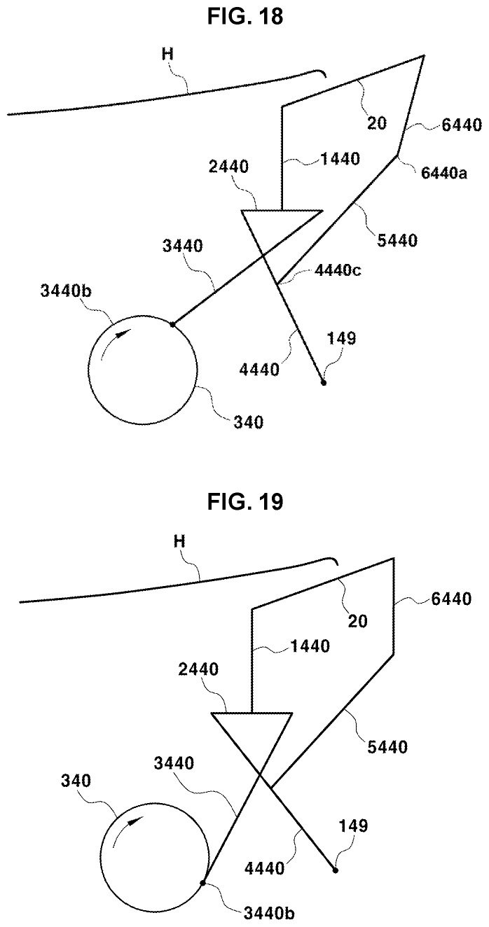

The operation of the link structure 440 according to an exemplary embodiment of the present disclosure will be described with reference to FIG. 16, FIG. 17, FIG. 18 and FIG. 19.

In FIG. 16, the wiper cover 20 is located in the state of being stored under the hood H. For example, the wiper cover 20 may be in the stored location when the wiper or the washer fluid is operated or the windshield or the wiper blade is replaced.

FIG. 17 shows that the stored wiper cover 20 in FIG. 16 starts being drawn out to the outside of the hood H. As the motor 240 rotates, the second direct link point 3440b of the direct link 3440 connected to the gear 340 moves upward, and moves the wiper cover 20 upwards. The indirect link 4440 connected to the direct link 3440 by the horizontal link 2440 is rotated clockwise with respect to the fixing portion 149. As the indirect link 4440 rotates, the connection link 5440 and the distal end link 6440, connected to the indirect link 4440, also moves upwards.

In FIG. 18, the wiper cover 20 is in a state of being completely drawn out to the outside of the hood H. As the motor 240 continues to rotate until the wiper cover 20 is drawn out, the second direct link 3440 is in a direction of being close to the end portion of the hood H. The indirect link 4440 is further rotated clockwise to further move the connection link 5440 and the distal end link 6440 upwards.

Furthermore, as shown in FIG. 19, the motor 240 further rotates to store the wiper cover 20 while moving the direct link 3440 downward. By moving the direct link 3440 downward, the indirect link 4440 pulls the connection link 5440 and the distal end link 6440 into the hood H while being rotated counterclockwise.

The wiper covering system according to an exemplary embodiment of the present disclosure may reduce the wind sound.

Furthermore, according to an exemplary embodiment of the present disclosure, to the wiper cover can prevent the wiper from being frozen when it snows while a vehicle is parked.

Furthermore, according to an exemplary embodiment of the present disclosure, it is possible to improve fuel efficiency through drag reduction caused by reducing the resistance of the wind when a vehicle travels.

Furthermore, according to an exemplary embodiment of the present disclosure, it is possible to improve the external beauty by avoiding exposure to the outside of the wiper.

Furthermore, the term related to a control device such as “controller”, “control apparatus”, “control unit”, “control device”, “control module”, or “server”, etc refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present disclosure. The control device according to exemplary embodiments of the present disclosure may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may process data according to a program provided from the memory, and may generate a control signal according to the processing result.

The control device may be at least one microprocessor operated by a predetermined program which may include a series of commands for carrying out the method included in the aforementioned various exemplary embodiments of the present disclosure.

The aforementioned invention can also be embodied as computer readable codes on a computer readable recording medium. The computer readable recording medium is any data storage device that can store data which may be thereafter read by a computer system and store and execute program instructions which may be thereafter read by a computer system. Examples of the computer readable recording medium include Hard Disk Drive (HDD), solid state disk (SSD), silicon disk drive (SDD), read-only memory (ROM), random-access memory (RAM), CD-ROMs, magnetic tapes, floppy discs, optical data storage devices, etc and implementation as carrier waves (e.g., transmission over the Internet). Examples of the program instruction include machine language code such as those generated by a compiler, as well as high-level language code which may be executed by a computer using an interpreter or the like.

In various exemplary embodiments of the present disclosure, each operation described above may be performed by a control device, and the control device may be configured by a plurality of control devices, or an integrated single control device.

In various exemplary embodiments of the present disclosure, the control device may be implemented in a form of hardware or software, or may be implemented in a combination of hardware and software.

Furthermore, the terms such as “unit”, “module”, etc. included in the specification mean units for processing at least one function or operation, which may be implemented by hardware, software, or a combination thereof

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A wiper covering system comprising:
a wiper cover; and
a drive mechanism connected to the wiper cover and including a link structure configured to move the wiper cover.

2. The wiper covering system of claim 1, wherein the drive mechanism includes a base movably supporting the link structure.

3. The wiper covering system of claim 1, wherein the drive mechanism includes:
a gear configured to rotate the link structure mounted thereto; and
a motor engaged to the gear and configured to provide a rotation force to the gear.

4. The wiper covering system of claim 3, including a motor control unit connected to the motor and configured to control driving of the motor.

5. The wiper covering system of claim 3,
wherein the drive mechanism includes a base movably supporting the link structure,
wherein the base includes a seat accommodating the motor thereon, and
wherein the seat is provided with a plurality of ribs protruding in an inward direction and spaced from each other in a circumferential direction of the seat, and the motor is supported by the plurality of ribs.

6. The wiper covering system of claim 5, wherein at least one of the plurality of ribs includes a heat dissipation fin.

7. The wiper covering system of claim 2, wherein the base includes at least one drain hole fluidically-communicating an inside with an outside of the base.

8. The wiper covering system of claim 1, wherein the drive mechanism includes:
a base; and
a direct link receiving a driving force and rotatably mounted to the base, wherein the direct link is configured to move the link structure connected to the direct link in upward or downward by rotation thereof.

9. The wiper covering system of claim 8, wherein the link structure includes:
a first link fixed to the wiper cover, wherein the direct link is rotatably connected to a first end portion of the first link;
an indirect link including a first indirect link point and a second indirect link point at opposite end portions of the indirect link, the first indirect link point being connected to a second end portion of the first link, and the second indirect link point rotatably connected to the base; and
a distal end link rotatably coupled to the wiper cover, wherein a connection link connected to the indirect link is rotatably coupled to the distal end link.

10. A vehicle comprising:
a wiper cover configured to be selectively movable between a stored location inside a hood of the vehicle and a drawn-out location on a windshield; and
a drive mechanism mounted on a cowl top cover disposed under the hood and connected to the wiper cover via at least two link structures to move the wiper cover.

11. The vehicle of claim 10, wherein one or more washer fluid nozzles configured to spray a washer fluid to the windshield are mounted on a lower portion of the wiper cover.

12. The vehicle of claim 11, wherein the one or more washer fluid nozzles are connected to a washer fluid supply hose flowing the washer fluid from a washer fluid supply in the vehicle, and the washer fluid supply hose extends along the wiper cover.

13. The vehicle of claim 10, wherein the drive mechanism includes at least two bases mounted at each end portion of the cowl top cover, each base having the link structure movably coupled thereto, respectively.

14. The vehicle of claim 13, wherein each base is inserted into respective accommodation portion formed on the cowl top cover.

15. The vehicle of claim 14, wherein a locking portion protruding from a surface of each base is disposed on at least a portion of each base inserted into the accommodation portion.

16. The vehicle of claim 10, including a control unit of a drive source configured to provide a moving force to the at least two link structures.

17. A method of operating the vehicle of claim 16, the method executable by the control unit, including:
receiving a turn-on input of the vehicle;
receiving an operation signal of a rain sensor of the vehicle; and
moving the wiper cover to the stored location by driving the drive source in response to the operation signal of the rain sensor.

18. The method of claim 17, further including:
receiving a turn-off input of the vehicle; and
moving the wiper cover to the drawn-out location by driving the drive source in response to the turn-off input.

19. The method of claim 17, further including:
maintaining the wiper cover in the drawn-out location and monitoring whether an operation signal of a wiper of the vehicle or a washer fluid spray signal of the vehicle is input when the operation signal of the rain sensor is not detected;
moving the wiper cover to the stored location by driving the drive source when the operation signal of the wiper or the washer fluid spray signal is detected; and
moving the wiper cover to the drawn-out location by driving the drive source when the operation signal of the wiper or the washer fluid spray signal detection is stopped, by the control unit.

20. The method of claim 19, further including:
receiving a turn-off input of the vehicle; and
maintaining the wiper cover in the drawn-out location in response to the turn-off input.
